(19) United States
(12) Patent Application Publication
(10) Pub. No.: US 2004/0117076 A1
(43) Pub. Date: Jun. 17, 2004

(54) Remote control system for locomotives using a TDMA communication protocol

(75) Inventor: Folkert Horst, Pierrefonds (CA)

Correspondence Address: DARBY & DARBY P.C., P. O. BOX 5257, NEW YORK, NY, 10150-5257, US

(73) Assignee: CANAC INC., St-Laurent (CA)

(21) Appl. No.: 10/727,935

(22) Filed: Dec. 2, 2003

Related U.S. Application Data
(60) Provisional application No. 60/430,044, filed on Dec. 2, 2002.

(51) Int. Cl. G05D 1/00

(52) U.S. Cl. 701/19; 375/295

(57) ABSTRACT

A system for remotely controlling one or more locomotives. The system includes a remote control unit on which a human operator enters commands, and a locomotive controller mounted in the locomotive to implement the commands. The remote control unit communicates with the locomotive controller over a radio frequency (RF) communication link. The communication link is a Time Division Multiple Access (TDMA) link. A TDMA arrangement allows several locomotives to be controlled by respective master controllers while constraining all the communication links to a common frequency band. To avoid conflicts, each communication link is assigned a different time interval. The length of the time interval can be varied according to selected parameters of the system, one such parameter being the number of locomotives currently controlled. When few locomotives are being currently controlled, the time interval assigned to each communication link can be expanded to provide increased bandwidth. When more locomotives are being controlled, shorter time intervals are used to accommodate the additional number of locomotives.

### CROSS REFERENCE TO RELATED APPLICATIONS

This application claims the benefit of U.S. provisional application serial No. 60/430,044 filed Dec. 2, 2002. The contents of the above document are incorporated herein by reference.

### FIELD OF THE INVENTION

The present invention relates to the field of communication and control systems for locomotives. It is particularly suitable to a method and apparatus for remotely controlling locomotives using a TDMA communication link.

### BACKGROUND OF THE INVENTION

Electronic controllers are commonly used in the industry to regulate the operation of a wide variety of systems. In a specific example, electronic controllers are used to remotely control vehicles such as locomotives in order to perform functions including braking and acceleration without the necessity of a human operator on board the locomotive. Radio frequency transmitter-receiver pairs are of particular interest for remotely controlling such vehicles. In a typical locomotive control system, the operator uses a remote control device to communicate with a locomotive controller located onboard the locomotive. The remote control device includes an electronic circuit placed in a suitable casing that provides mechanical protection to the electronic components.

In use, the operator of the locomotive enters requests into the remote control device via inputs such as switches, a keyboard, a touch sensitive screen or any other suitable input. Typical requests may include braking, accelerating and any other function that a locomotive may be required to perform. The remote control device encodes the request into a form suitable for transmission over a given communication link. The complete request is then modulated at a pre-determined radio frequency and transmitted as an RF signal. Frequencies other than RF have also been used for this purpose. The locomotive controller onboard the locomotive receives and demodulates the RF signal originating from the remote control unit. Optionally, the locomotive controller onboard the locomotive may also transmit information back to the remote control unit. In such a case, the locomotive controller encodes the information into a form suitable for transmission over a given communication link. The encoded information is then modulated at a pre-determined radio frequency and transmitted as a RF signal. The remote control unit is equipped with a receiver to receive and demodulate the RF signal originating from the locomotive controller.

Due to the very limited availability of expensive, licensed frequency spectrum, many remote control units and locomotive controllers must operate on a same radio frequency channel or on overlapping radio frequency channels often resulting in interference between the various signals. Signals simultaneously transmitted in overlapping frequency channels cannot be resolved into their respective signals by a receiver in the locomotive controller (or the remote control unit in the case of a signal transmitted from the locomotive controller). The interference of the signals typically causes requests to be lost. Many methods have been proposed for reducing the effects of interference and controlling access to the communication channels.

Two commonly used categories of channel access methods are contention protocols and time-division multiple-access (TDMA) protocols.

Contention protocols allow each unit in the communication system to transmit (or attempt to transmit) at will, with the resulting occurrence of message collisions. In such protocols, a signal is transmitted repetitively at a constant or variable repetition rate. Certain ones of the transmissions collide with others and do not successfully arrive at their destination while others arrive successfully. For examples of methods for assigning repetition rates, the reader may refer to U.S. Pat. No. 4,245,347 by Hutton et al., and U.S. Pat. No. 6,456,674 entitled “Method and apparatus for automatic repetition rate assignment in a remote control system” by Horst et al. whose contents are hereby incorporated by reference.

Conversely, TDMA protocols require that a fixed period of time be divided into time intervals reserved specifically for transmissions from individual communication entities (e.g. remote control units or locomotive controllers). In theory, no conflicts or message collisions will occur as a result of other stations operating within the protocol scheme. Interference and signal strength issues still exist and result in missed messages.

A deficiency with the existing TDMA protocols is that the time intervals in each TDMA frame are determined based on the largest number of communication entities capable of being supported in the communication system. This results in inefficient use of bandwidth when less than the largest number of communication entities possible are using the common communication link.

As such, there exists a need in the industry for an improved method and apparatus for allocating bandwidth on a communication link for a locomotive remote control system.

### SUMMARY

In accordance with a broad aspect, the present invention provides a locomotive remote control system that includes a plurality of remote control units and a plurality of locomotive controllers. Each remote control unit is adapted for receiving commands to be implemented by a locomotive. The plurality of locomotive controllers are suitable for mounting on-board respective locomotives and are adapted for causing their respective locomotives to implement commands. The plurality of remote control units and the plurality of locomotive controllers are capable of communicating with one another over a common communication link. The common communication link includes a plurality of TDMA frames, each TDMA frame including a set of time intervals, at least some time intervals in the set of time intervals being assigned to respective remote control units in the plurality of remote control units. The time intervals in the set of time intervals have a time interval length, wherein the time interval length is variable.

In accordance with another broad aspect, the present invention provides a remote control unit suitable for use in a locomotive remote control system. The locomotive remote control system includes a plurality of remote control units and a plurality of locomotive controllers that communicate with one another over a common communication link. The remote control unit comprises a user interface, a control entity and a communication interface. The user interface is suitable for enabling a human operator to enter commands to be implemented by a locomotive. The control entity is in communication with the user interface and is responsive to commands received at the user interface for generating command signals for transmission to a locomotive. The communication interface is in communication with the control entity and is adapted for transmitting the command signals to the locomotive over a communication link during at least one time interval in a TDMA frame. The communication link includes a plurality of TDMA frames, each including a set of time intervals. The time intervals in the set of time intervals have a time interval length that is variable. At least one time interval in the set of time intervals is assigned to a remote control unit.

In accordance with yet another broad aspect, the present invention provides a network entity suitable for use in a locomotive remote control system. The network entity is operative for managing the assignment of time intervals in a TDMA frame for a number of communication entities in the locomotive remote control system. The network entity comprises an input, a processing unit and an output. The input is operative for receiving from a communication entity a signal conveying a change in the number of communication entities in the locomotive remote control system. The processing unit. is in communication with the input, and is responsive to the signal conveying a change in the number of communication entities in the locomotive remote control system for deriving a time interval length associated to the time intervals in a TDMA frame. The output is operative for releasing a control signal adapted for causing at least one time interval in the TDMA frame to be assigned to a communication entity in the locomotive remote control system.

In accordance with yet another broad aspect, the present invention provides a remote control unit suitable for use in a locomotive remote control system. The locomotive remote control system includes a plurality of remote control units and a plurality of locomotive controllers that communicate with one another over a common communication link. The remote control unit comprises means for enabling a human operator to enter commands to be implemented by a locomotive and means for generating command signals for transmission to a locomotive in response to commands entered by a human operator. The remote control unit further comprises means for transmitting the command signals to a locomotive over a communication link during at least one time interval. The communication link includes a plurality of TDMA frames that each include a set of time intervals. The time intervals in the set of time intervals have a time interval length that is variable. At least one time interval in the set of time intervals is assigned to the remote control unit.

In accordance with yet another broad aspect, the present invention provides a method of assigning time intervals in a TDMA frame to communication entities in a locomotive remote control system. The method comprises receiving a signal conveying a change in the number of communication entities in the locomotive remote control system, deriving a time interval length associated to the time intervals in the TDMA frame on the basis of the signal conveying a change in the number of communication entities and assigning at least one time interval in the TDMA frame to each communication entity in the locomotive remote control system.

In accordance with yet another broad aspect, the present invention provides a locomotive remote control system that includes a plurality of remote control units and a plurality of locomotive controllers. The remote control units are adapted for receiving commands to be implemented by a locomotive and the plurality of locomotive controllers are suitable for mounting on-board respective locomotives. The locomotive controllers in the plurality of locomotive controllers are adapted for causing their respective locomotives to implement commands. The plurality of remote control units and the plurality of locomotive controllers are capable of communicating with one another over a common communication link. The common communication link includes a plurality of TDMA frames that each include a set of time intervals with at least some time intervals in the set of time intervals being assigned to respective remote control units in the plurality of remote control units. Each TDMA frame has a length, wherein the length is variable.

### BRIEF DESCRIPTION OF THE DRAWINGS

A detailed description of examples of implementation of the present invention is provided hereinbelow with reference to the following drawings, in which:

FIG. 1 shows a block diagram of a remote control system for locomotives, in accordance with a non-limiting embodiment of the present invention;

FIG. 2 shows a more detailed block diagram of a remote control unit/locomotive entity pair suitable for use in the system shown in FIG. 1, in accordance with a non-limiting embodiment of the present invention;

FIG. 3 shows a block diagram of a remote control system comprising a network entity for assigning time intervals in accordance with a non-limiting embodiment of the present invention;

FIG. 4 shows a block diagram of a remote control system where the assignment of time intervals is performed by the locomotive entities in accordance with an alternative embodiment of the present invention;

FIGS. 5a and 5b show the division of time intervals within a TDMA frame in accordance with a non-limiting example of implementation;

FIG. 6 shows a block diagram a of computing unit suitable for assigning time intervals to communication entities in a communication system in accordance with a non-limiting embodiment of the present invention.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

FIG. 1 illustrates a remote control system 10 for controlling a plurality of locomotive entities 22-30 in accordance with a specific example of implementation of the present invention. The system 10 includes a plurality of remote control units 12-20 and corresponding locomotive controllers for mounting on-board respective locomotive entities 22-30. In use, a human operator that is responsible for controlling a given one of the locomotive entities 22-30 carries a respective one of the remote control units 12-20. The operator selects commands or functions from a user interface located on the respective one of the remote control units 12-20. The commands are communicated to a respective one of the locomotive entities 22-30, where the commands are implemented. Examples of commands include acceleration commands for causing the locomotive entity to move, brake commands for causing the locomotive entity to brake, horn commands, coast commands, and direction of movement commands, among others.

The commands are sent from the remote control units 12-20 to respective locomotive entities 22-30 over a common RF communication link. The system 10 can be designed with a unidirectional communication capability, wherein the remote control units 12-20 can only send commands to the respective locomotive entities 22-30. In addition, the remote control units 12-20 are adapted for receiving inputs conveying timing information related to the allocation of time intervals in a TDMA frame. Alternatively, the system 10 can be provided with a bi-directional communication capability wherein the remote control units 12-20 can send commands to, and receive signals from, the locomotive entities 22-30. In this alternative implementation, the remote control units 12-20 and the locomotive controllers onboard the locomotive entities 22-30 are adapted for receiving inputs conveying timing information related to the allocation of time intervals in a TDMA frame.

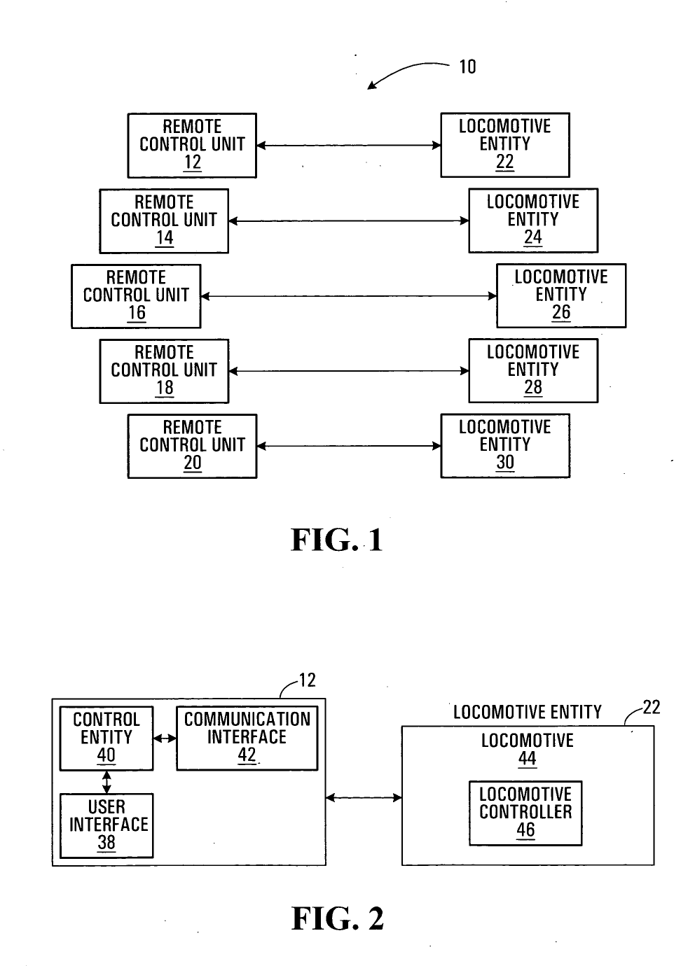

FIG. 2 is a block diagram that illustrates in greater detail the structure of a remote control unit 12 and the structure of a locomotive entity 22. In accordance with a non-limiting implementation, the remote control units 14-20 are substantially the same as remote control unit 12, and the locomotive entities 24-30 are substantially the same as locomotive entity 22, and as such, only remote control unit 12 and locomotive entity 22 have been shown in greater detail in FIG. 2. The remote control unit 12 includes a user interface 38, with which the operator communicates with the remote control unit 12. Stated otherwise, the operator enters commands to be implemented by the locomotive entity 22 via the user interface 38. If the remote control unit 12 is designed to communicate information back to the operator, such information is also communicated via the user interface 38. Examples of components of the user interface 38 may include, for example, manually operable switches, a keyboard, a touch sensitive screen, pointing devices, voice recognition devices, a display screen, and a speech synthesizer, among others. The remote control unit 12 also includes a control entity 40. The control entity 40 provides the main controlling function of the remote control unit 12. The control entity 40 can be implemented in hardware, in software or as a combination of hardware and software. The remote control unit 12 further includes a communication interface 42 via which the remote control unit 12 can communicate over an RF communication link 34 with the locomotive entity 22, as shown in FIG. 1. Communication paths within the remote control unit 12 connect the user interface 38, the control entity 40 and the communication interface 42 to allow internal signals to be exchanged between those components.

The locomotive entity 22 is a combination of two components namely a locomotive 44 and a locomotive controller 46 mounted on board the locomotive 44. It is the locomotive controller 46 that receives the commands issued by the remote control unit 12 over the RF communication link 34. The locomotive controller 46 interfaces with the various locomotive controls in a known manner such as to implement the commands received from the remote control unit 12.

In a specific example of implementation, each remote control unit 12-20 and each locomotive controller 46 communicate over the common communication link using one or more time intervals in a TDMA frame. In a non-limiting embodiment, each one of the remote control units 12-20 is assigned a single time interval per TDMA frame, however, in an alternative, non-limiting embodiment, one or more of the remote control units 12-20 is assigned more than one time interval per TDMA frame. The multiple time intervals assigned can be adjacent one another, or separated by other time intervals in the TDMA frame. Each time interval is characterized by a certain length and each remote control unit 12-20 and locomotive controller 46 in the system 10 communicates over one or more different time intervals in the TDMA frame. In this manner, communication conflicts are avoided. For the remainder of the description, the term “communication entities” will be used to refer to one or both of remote control units 12-20 and the locomotive controllers 46 contained in the locomotive entities 22-30.

In a non-limiting example of implementation, each communication entity can be assigned a pre-determined time interval. As such, data sent from the remote control unit 12 to the locomotive entity 22 is constrained to a pre-determined time interval and data sent in the reverse direction, i.e., from the locomotive entity 22 to the remote control unit 12 is also constrained to a predetermined time interval. In an alternative embodiment, a communication link 34 between a given remote control unit and a given locomotive entity is assigned a time interval in a TDMA frame such that it is up to the remote control unit 12 and the locomotive entity 22 to determine when one can send information over the TDMA communication link and the other should listen, and vice-versa. Such synchronization can be achieved by using a communication protocol that authorizes one of the units (remote control unit 12, locomotive entity 22) to start sending information only when that unit has observed the end of a message from the other entity.

The length of a time interval in a TDMA frame can be varied depending on operational parameters. One such parameter is the number of locomotive entities concurrently being controlled over the common communication link, or the number of communication entities (i.e. remote control units and locomotive controllers) concurrently using the communication link. Purely from a communications perspective, it is desirable to assign longer time intervals or alternatively a larger number of time intervals, to communication entities in order to provide increased bandwidth. This, however, limits the number of communication entities that can concurrently use the communication link. To increase the number of communication entities that can concurrently use the communication link, more time intervals are needed which requires shortening the time intervals.

In an alternative embodiment, the length of the TDMA frame can vary depending on the number of time intervals contained therein. In the case where there are a large number of time intervals for allowing a large number of communication entities to use the communication link, the TDMA frame is of a longer length than when fewer time intervals are included in the TDMA frame.

Accordingly, the TDMA communication system can be designed to allow a variation in the length of the one or more time intervals contained within a TDMA frame depending on one or more pre-determined operational parameters, or the TDMA communication system can be designed to allow a variation in the length of the TDMA frame by including more or less time intervals within the TDMA frame depending on one or more pre-determined operational parameters. One of those parameters is the number of remote control units concurrently transmitting control signals, and another one of those parameters is the number of locomotive entities concurrently being controlled. Alternatively, the number of time intervals in a TDMA frame assigned to a given communication entity may vary on the basis of one or more operational parameters.

The expression “length of a time interval” simply refers to the duration of time allocated to a given communication entity for transmitting over a communication link 34, in a communication cycle. In a system that uses a communication cycle divided into a fixed number of time intervals, varying the length of a time interval means assigning more or less time intervals to the communication entities. The time intervals so assigned do not need to be contiguous. In the case of a system where the number of time intervals per communication cycle is not fixed, varying the length of a time interval can be accomplished by varying the number of time intervals in a communication cycle; fewer time intervals means time intervals of longer duration, while more time intervals means time intervals of shorter duration.

By “knowing” the number of communication entities that are concurrently using the communication link, the length of the time interval assigned to each communication entity can be derived.

In one non-limiting example of implementation, the assignment mechanism is a manual approach where a human operator enters in each communication entity, i.e. each remote control unit 12-20 and each locomotive controller 22-30 in the case of bi-directional communication, information about the number of communication entities in the system 10. In this implementation, the remote control units 12-20 and optionally the locomotive controllers 22-30 in the case of bi-directional communication include a user operable input adapted for receiving the above described information. In addition, the operator may also specify which time interval will be used by each communication entity. In the situation where there is uni-directional transmission between the remote control units 12-20 and the locomotive entities 22-30, a human operator will only enter the assignment information into the remote control units 12-20. This approach of manually assigning time intervals is simple but the parameters have to be manually updated when the number of communication entities concurrently using the RF communication link changes.

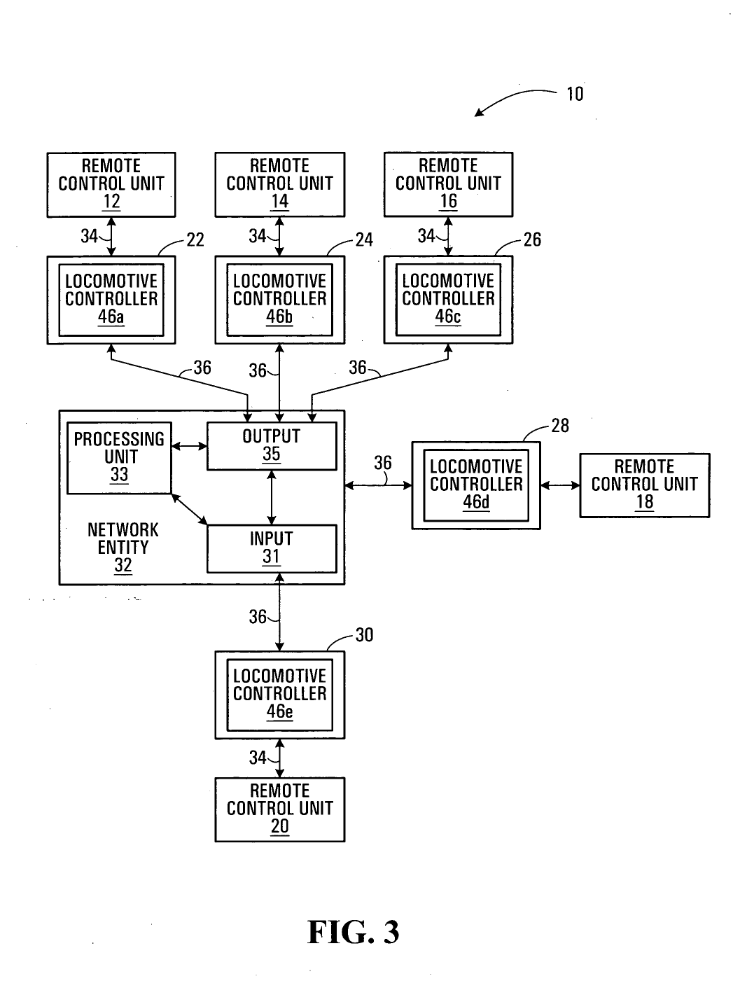

In another non-limiting example of implementation, the configuration information about the number of communication entities concurrently using the communication link, the time interval assignment and the length of each time interval is controlled and communicated through a central network entity 32, of the type shown in FIG. 3.

In the example of implementation shown in FIG. 3, let us assume that the locomotive entities 22-28 are located within a switchyard, and are concurrently being controlled by their respective remote control units 12-18 over communication links 34. The network entity 32 is aware of the number of locomotive entities concurrently being controlled within the switchyard, and is aware of the number of communication entities concurrently using the common communication link. Now let us assume that locomotive entity 30 enters the switchyard, and would like to be added to the set of locomotive entities that are concurrently being controlled by their respective remote control units over communication link 34. In order to be added to the set, the locomotive controller 46e of the locomotive entity 30 transmits an entry request signal to the network entity 32 over communication link 36.

The communication link 36 can use an RF communication link that is separate from the RF communication link used by the communication links 34, or alternatively, the communication link 36 and the communication link 34 can be the same communication link. In the case where the communication link 36 use a separate RF communication link, the locomotive entities 22-30 in the switching yard communicate with the network entity 32 through the communication links 36, which can be of wireline or wireless nature and arranged to form a network. Alternatively, in the case where the communication links 36 use the same communication link as communication links 34, the TDMA frame may include a time interval assigned to communication to/from the network entity during which the locomotive controllers 46a-46e of the locomotive entities 22-30 are able to communicate with the network entity 32.

In the example shown in FIG. 3, prior to the network entity 32 receiving the request signal from the locomotive controller 46e of locomotive entity 30, there were four locomotive entities 22-28 concurrently being controlled over communication links 34. In a non-limiting implementation, the RF communication link used between the remote control units 12-18 and the locomotive controllers 46a-d of the locomotive entities 22-28 includes TDMA frames divided into 8 time intervals. These 8 time intervals would have included one time interval assigned to each of the four remote control units 12-18 for transmitting to their respective locomotive controllers 46a-46d, and one time interval assigned to each of the four locomotive controllers 46a-46d for transmitting to their respective remote control units 12-18. In the case where the communication link 36 is the same RF communication link as the communication link 34, the TDMA frame may be divided to include a 9^{th} time interval during which the locomotive controllers 46a-46e can communicate with the network entity 32.

The network entity 32 receives the signal from the locomotive controller 46e at its input 31, and passes that signal to its processing unit 33. Once the network entity 32 has received the request signal from the locomotive controller 46e, the processing unit 33 determines the number of time intervals needed within the TDMA frame, and the length of each of the new time intervals. In the example shown, upon receipt of the request signal from the locomotive controller 46e, the network entity 32 would divide the TDMA frame into 10 time intervals in order to take into consideration an additional time interval for the locomotive controller 46e to transmit to the remote control unit 20 and an additional time interval for the remote control unit 20 to transmit to the locomotive controller 46e. As such, each of the 10 time intervals in the TDMA frame will have a shorter length of time than the 8 previous time intervals in the TDMA frame. Once calculated, the network entity 32 transmits a signal from its output 35 over the communication links 36 to the locomotive controllers 46a-46e in order to assign the new time intervals to the locomotive controllers 46a-46e. The locomotive controllers 46a-46e then communicate the time intervals assigned to their respective remote control units 12-20 to the remote control units 12-20 over communication links 34. Alternatively, the network entity 32 may communicate directly with the remote control units 12-20.

The remote control units 12-20 and the locomotive controllers 46a-e are synchronized using a common clock. The time synchronization for remote control units 12-20 and the locomotive entities 22-30 can be based on a central clock located at the network entity 32, or via a GPS clock system.

It should be understood that the same procedure can take place when one of the locomotive entities 22-30 decides to leave the switchyard, only instead of the locomotive entity sending a request signal to the network entity 32, the locomotive entity would send a removal signal. Upon receipt of a removal signal, the network entity 32 would recalculate the number of locomotive entities, and re-assign time intervals having a longer length of time to each of the remaining locomotive entities.

Although FIG. 3 depicts the network entity 32 as being in communication with the locomotive controllers 46a-46d of the locomotive entities 22-30, it is also possible that in the case where there is uni-directional communication between the remote control units 12-20 and the locomotive entities 22-30, that it is the remote control units 12-20 that are in communication with the network entity 32. In such a case, the network entity 32 would divide the TDMA frame into five time intervals containing one time interval during which each of the remote control units 12-20 is able to transmit to the locomotive entities 22-30.

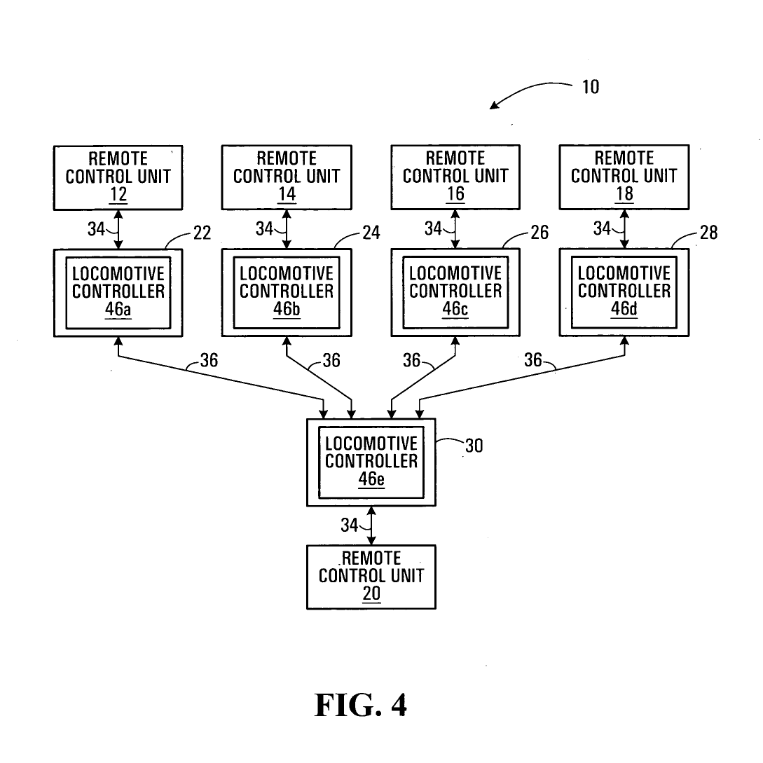

In an alternative example of implementation, it is the locomotive controllers 46a-46e that control the assignment of the time intervals, and length of the time intervals, that are used by the communication entities that are concurrently using the common RF communication link. Shown in FIG. 4, is a non-limiting example of implementation wherein it is the locomotive entities 22-30 that negotiate between themselves in order to automatically configure the TDMA frames in the communication link according to the number of communication entities concurrently using the communication link.

In one example of implementation, each locomotive entity performs an auto-discovery procedure such that the locomotive entities are able to determine the total number of communication entities concurrently using the communication link. The auto-discovery procedure can involve each locomotive entity listening for a certain period of time to “hear” all the other locomotive entities present, and on the basis of this information determine the length of the time interval to be used. In one example of implementation, the locomotive entities are distinguished from one another on the basis of their addresses. As for time interval assignment (i.e. the sequence of transmission), each locomotive entity will occupy a given interval if this interval is free. The duration of each time interval is determined and adjusted automatically by each locomotive entity on the basis of the total number of active locomotive entities in the yard.

In the example of implementation shown in FIG. 4, when a new locomotive entity, such as locomotive entity 30, reaches the switchyard, the new locomotive entity 30 listens to discover the total number of locomotive entities that are concurrently being controlled over the common communication link. In one non-limiting example of implementation, the new locomotive entity 30 might count the number of addresses contained in the messages sent between the locomotive entities 22-28 and the remote control units 12-18. In the case shown in FIG. 4, after listening for a predetermined period of time to the messages sent over link 34, the locomotive controller 46e of the locomotive entity 30 would count eight addresses; namely one address for each of the four remote control units 12-18 and one address for each of the four locomotive controllers 46a-46d. In addition, based on the repetition of each address, the locomotive controller 46e would be able to determine the fixed amount of time for each TDMA frame. Once the locomotive has determined the number of communication entities concurrently using the common RF communication link, the new locomotive entity 30 transmits a signal indicative of its presence to the other locomotive entities 22-28, over a free time interval in the TDMA frame, or over a separate RF communication link.

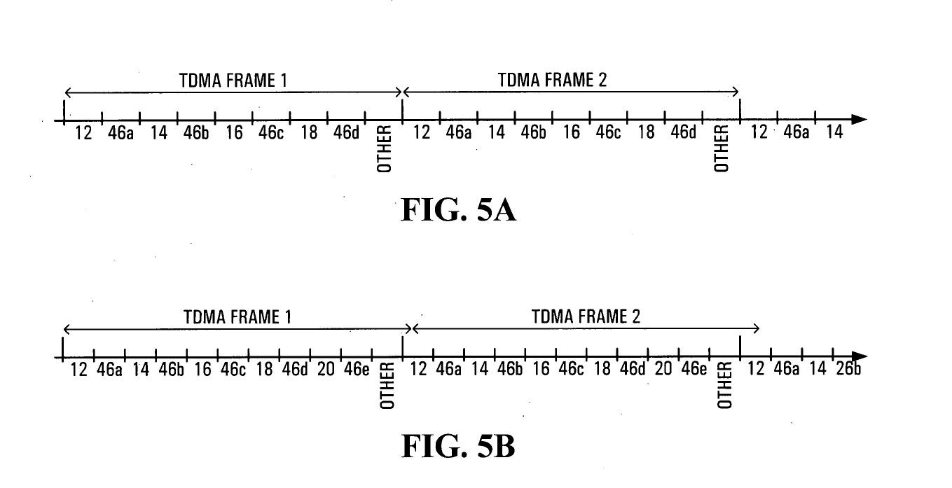

Upon receipt of this signal, each locomotive entity 22-29 in the switchyard (including the new locomotive entity 30) is aware of the new total number of locomotive entities in the set, and is able to initiate a recalculation procedure in order compute the number and length of time of the new time intervals. Shown in FIG. 5a is an example of a TDMA frame prior to locomotive entity 30 transmitting the signal indicative of its presence. As shown, each TDMA frame is divided into 9 time intervals, with one for each communication entity and one “other” time interval for receiving signals indicative of the arrival or removal of a locomotive entity from the set. Shown in FIG. 5b is an example of a TDMA frame once the locomotive entities 22-30 have recalculated the time intervals. As shown, each of the TDMA frames in FIG. 5b, are divided into 11 time intervals with an additional time interval for each communication entity and one “other” time interval for receiving signals indicative of the arrival or removal of a locomotive entity from the set. In the example shown, the new locomotive entity 30 takes the last two time intervals before the “other” time interval. As shown in FIGS. 5a and 5b, the fixed period of time for each TDMA frame remains the same, but the length of the time intervals in the TDMA frame shown in FIG. 5b are shorter than those in FIG. 5a. It should be understood that in an alternative embodiment, the length of the time intervals could have remained the same, and the TDMA frame could have been lengthened.

This recalculation process can be performed independently at each locomotive entity 22-30, so long as each locomotive entity understands where it fits into the order of the time intervals, and where the time intervals for a new locomotive entity will be positioned. In the example shown, the time intervals for the new locomotive entity are located at the end of the TDMA frame. Once the recalculation procedure is performed by each respective locomotive entity, each one of them makes the adjustment automatically. It should be understood that in an alternative example of implementation, the locomotive controllers 46a-46e can communicate with each other over a separate communication link 36 in order to confirm that they have each recalculated the time intervals in the TDMA frames.

In an alternative embodiment, the locomotive entities in the set can always be “listening” to communication link 34 for the number of communication entities in the set. As such, upon detection of a new communication entity the remaining communication entities can perform the recalculation procedure in order to readjust the assignment and length of time for the time intervals in the TDMA frame. As such, the locomotive controllers 46a-46e do not communicate with each other and there is no need for the communication link 36 as shown in FIG. 4.

In the case where a locomotive entity leaves the switchyard, it can notify the other locomotive entities either by sending an explicit message or simply leave. In the later case, each of the remaining locomotive entities is configured to monitor and continuously detect the presence of the other locomotive entities. If a transmission from one locomotive entity is not detected over a certain time period, all the remaining locomotive entities will assume that that locomotive entity has left the yard or has ceased it operation. At this point the time interval adjustment is performed again, as described earlier.

Those skilled in the art should appreciate that in some embodiments of the invention, all or part of the functionality previously described herein with respect to the network entity 32 the locomotive controllers and remote control units may be implemented as pre-programmed hardware or firmware elements (e.g., application specific integrated circuits (ASICs), electrically erasable programmable read-only memories (EEPROMs), etc.), or other related components.

In other embodiments of the invention, all or part of the functionality previously described herein with respect to the network entity 32 the locomotive controllers and the remote control units may be implemented as software consisting of a series of instructions for execution by a computing unit. The series of instructions could be stored on a medium which is fixed, tangible and readable directly by the computing unit, (e.g., removable diskette, CD-ROM, ROM, PROM, EPROM or fixed disk), or the instructions could be stored remotely but transmittable to the computing unit via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared or other transmission schemes).

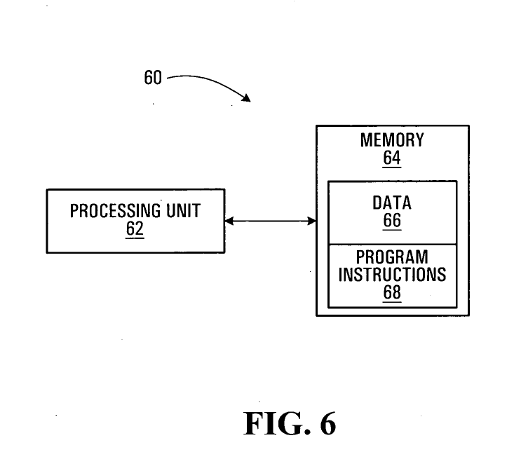

The computing unit implementing the functionality of the network entity 32, the locomotive controllers or the remote control units may be configured as a computing unit 60 of the type depicted in FIG. 6, including a processing unit 62 and a memory 64 connected by a communication bus 66. The memory 64 includes data 66 and program instructions 68. The processing unit 62 is adapted to process the data 66 and the program instructions 68 in order to implement the functionality described in the specification and depicted in the drawings. The computing unit 60 may also comprise an I/O interface for receiving or sending data elements to external devices.

Those skilled in the art should further appreciate that the program instructions 68 may be written in a number of programming languages for use with many computer architectures or operating systems. For example, some embodiments may be implemented in a procedural programming language (e.g., “C”) or an object oriented programming language (e.g., “C++” or “JAVA”).

The above description of embodiments should not be interpreted in a limiting manner since other variations, modifications and refinements are possible within the spirit and scope of the present invention. The scope of the invention is defined in the appended claims and their equivalents.

1) A locomotive remote control system including:
a) a plurality of remote control units, each remote control unit being adapted for receiving commands to be implemented by a locomotive;
b) a plurality of locomotive controllers suitable for mounting on-board respective locomotives, the locomotive controllers in the plurality of locomotive controllers being adapted for causing their respective locomotives to implement commands;
c) said plurality of remote control units and said plurality of locomotive controllers being capable of communicating with one another over a common communication link, the common communication link including a plurality of TDMA frames, each TDMA frame including a set of time intervals, at least some time intervals in the set of time intervals being assigned to respective remote control units in the plurality of remote control units, the time intervals in the set of time intervals having a time interval length, the time interval length being variable.

2) A locomotive remote control system as defined in claim 1, wherein said time interval length is derived at least in part on the basis of the number of remote control units in said plurality of remote control units.

3) A locomotive remote control system as defined in claim 1, wherein said time interval length is derived at least in part on the basis of the number of locomotive controllers in said plurality of locomotive controllers.

4) A locomotive remote control system as defined in claim 1, wherein said time interval length is derived at least in part on the basis of the number of locomotive controllers and the number of remote control units in said remote control system.

5) A locomotive remote control system as defined in claim 1, wherein at least one locomotive controller in the plurality of locomotive controllers is operative for determining said time interval length.

6) A locomotive remote control system as defined in claim 1, wherein said system further includes a network entity in communication with said plurality of remote control units, said network entity being operative for determining said time interval length.

7) A locomotive remote control system as defined in claim 1, wherein said system further includes a network entity in communication with said plurality of locomotive controllers, said network entity being operative for determining said time interval length.

8) A locomotive remote control system as defined in claim 1, wherein at least some time intervals in the set of time intervals being assigned to respective locomotive controllers in said plurality of locomotive controllers.

9) A remote control unit suitable for use in a locomotive remote control system, the locomotive remote control system including a plurality of remote control units and a plurality of locomotive controllers communicating with one another over a common communication link, said remote control unit comprising:
a) a user interface suitable for enabling a human operator to enter commands to be implemented by a locomotive;
b) a control entity in communication with said user interface, said control entity being responsive to commands received at said user interface operative for generating command signals for transmission to a locomotive;
c) a communication interface in communication with said control entity, said communication interface being adapted for transmitting said command signals to a locomotive over a communication link during at least one time interval, the communication link including a plurality of TDMA frames, each TDMA frame including a set of time intervals, the time intervals in the set of time intervals having a time interval length, the time interval length being variable, at least one time interval in said set of time intervals being assigned to said remote control unit.

10) A remote control unit as defined in claim 9, wherein said time interval length is derived at least in part on the basis of the number of remote control units in the plurality of remote control units.

11) A remote control unit as defined in claim 9, wherein said time interval length is derived at least in part on the basis of the number of locomotive controllers in the plurality of locomotive controllers.

12) A remote control unit as defined in claim 9, wherein said time interval length is derived at least in part on the basis of the number of locomotive controllers and the number of remote control units in the remote control system.

13) A remote control unit as defined in claim 9, wherein said remote control unit is operative for determining said time interval length.

14) A remote control unit as defined in claim 9, wherein said remote control unit is operative for communicating with a network entity, said network entity being operative for determining said time interval length.

15) A network entity suitable for use in a locomotive remote control system, said network entity being operative for managing the assignment of time intervals in a TDMA frame for a number of communication entities in the locomotive remote control system, said network entity comprising:
a) an input for receiving from a communication entity a signal conveying a change in the number of communication entities in the locomotive remote control system;
b) a processing unit in communication with said input, said processing unit being responsive to the signal conveying a change in the number of communication entities in the locomotive remote control system for deriving a time interval length associated to the time intervals in a TDMA frame;
c) an output for releasing a control signal adapted for causing at least one time interval in the TDMA frame to be assigned to a communication entity in the locomotive remote control system.

16) A network entity as defined in claim 15, wherein said processing unit is responsive to the signal conveying a change in the number of communication entity for deriving a number of communication entities in the locomotive remote control system.

17) A network entity as defined in claim 16, wherein said processing unit is further operative for deriving a number of time intervals in the TDMA frame.

19) A network entity as defined in claim 15, wherein said number of communication entities includes a number of remote control units for transmitting commands to be implemented by a locomotive.

20) A network entity as defined in claim 19, wherein said number of communication entities includes a number of locomotive controllers for receiving commands from said remote control units.

21) A network entity as defined in claim 15, wherein said signal indicative of a change in the number of communication entities in the locomotive remote control system is indicative of an increase in the number of communication entities in the locomotive remote control system.

22) A network entity as defined in claim 15, wherein said signal indicative of a change in the number of communication entities in the locomotive remote control system is indicative of a decrease in the number of communication entities in the locomotive remote control system.

23) A remote control system for a locomotive, including:
a) a remote control unit at which an operator can enter commands to be implemented by a locomotive;
b) a locomotive controller for mounting on-board a locomotive for interfacing with the locomotive and cause the locomotive to implement commands;
c) said remote control unit and said locomotive controller capable of communicating with one another over a communication link, said communication link including a plurality of TDMA frames, each TDMA frame including a set of time intervals, the time intervals in the set of time intervals having a time interval length, the time interval length being variable.

24) A remote control unit suitable for use in a locomotive remote control system, the locomotive remote control system including a plurality of remote control units and a plurality of locomotive controllers communicating with one another over a common communication link, said remote control unit comprising:
a) means for enabling a human operator to enter commands to be implemented by a locomotive;
b) means for generating command signals for transmission to a locomotive in response to commands received at said means for enabling a human operator to enter commands;
c) means for transmitting said command signals to a locomotive over a communication link during at least one time interval, the communication link including a plurality of TDMA frames, each TDMA frame including a set of time intervals, the time intervals in the set of time intervals having a time interval length, the time interval length being variable and at least one time interval in said set of time intervals being assigned to said remote control unit.

25) A method of assigning time intervals in a TDMA frame to communication entities in a locomotive remote control system, said method comprising:
a) receiving a signal conveying a change in the number of communication entities in the locomotive remote control system;
b) deriving a time interval length associated to the time intervals in the TDMA frame on the basis of said signal conveying a change in the number of communication entities in the locomotive remote control system;
c) assigning at least one time interval in the TDMA frame to each communication entity in the locomotive remote control system.

26) A locomotive remote control system including:
a) a plurality of remote control units, each remote control unit being adapted for receiving commands to be implemented by a locomotive;
b) a plurality of locomotive controllers suitable for mounting on-board respective locomotives, the locomotive controllers in the plurality of locomotive controllers being adapted for causing their respective locomotives to implement commands;
c) said plurality of remote control units and said plurality of locomotive controllers being capable of communicating with one another over a common communication link, the common communication link including a plurality of TDMA frames, each TDMA frame including a set of time intervals, at least some time intervals in the set of time intervals being assigned to respective remote control units in the plurality of remote control units, each TDMA frame having a length, the length being variable.
